(19) United States
(12) Patent Application Publication
(10) Pub. No.: US 2026/0270875 A1
(43) Pub. Date: Sep. 10, 2026

(54) ZONE-BASED PARTITIONING OF LOW POWER WAKEUP SIGNAL MONITORING PERIODICITIES

(71) Applicant: QUALCOMM Incorporated, San Diego, CA (US)

(72) Inventors: Huilin XU, Temecula, CA (US); Prashant SHARMA, San Marcos, CA (US); Igor GUTMAN, Hod HaSharon (IL); Kazuki TAKEDA, Minato-ku (JP); Sumant Jayaraman IYER, San Diego, CA (US); Nicolas CORNILLET, Lannion (FR)

(21) Appl. No.: 19/070,449

(22) Filed: Mar. 4, 2025

(51) Int. Cl. H04W 52/02

(52) U.S. Cl. CPC H04W 52/0235; H04W 52/0212

(57) ABSTRACT

Various aspects of the present disclosure generally relate to wireless communication. In some aspects, a user equipment (UE) may receive an indication of a zone pattern associated with a zone-based partitioning of a low power wakeup signal (LP-WUS) monitoring periodicity. The UE may receive, during a zone associated with the zone pattern, an LP-WUS, wherein the zone is associated with a UE sleep mode, and wherein the UE sleep mode is associated with a UE main radio wakeup time. The UE may receive a downlink control channel signal based at least in part on the UE main radio wakeup time. Numerous other aspects are described.

### FIELD OF THE DISCLOSURE

Aspects of the present disclosure generally relate to wireless communication and specifically relate to techniques, apparatuses, and methods associated with zone-based partitioning of low power wakeup signal monitoring periodicities.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

### SUMMARY

In some implementations, an apparatus for wireless communication at a user equipment (UE) includes one or more memories; and one or more processors, coupled to the one or more memories, configured to cause the UE to: receive an indication of a zone pattern associated with a zone-based partitioning of a low power wakeup signal (LP-WUS) monitoring periodicity; receive, during a zone associated with the zone pattern, an LP-WUS, wherein the zone is associated with a UE sleep mode, and wherein the UE sleep mode is associated with a UE main radio wakeup time; and receive a downlink control channel signal based at least in part on the UE main radio wakeup time.

In some implementations, an apparatus for wireless communication at a network node includes one or more memories; and one or more processors, coupled to the one or more memories, configured to cause the network node to: transmit an indication of a zone pattern associated with a zone-based partitioning of an LP-WUS monitoring periodicity; transmit, during a zone associated with the zone pattern, an LP-WUS, wherein the zone is associated with a UE sleep mode, and wherein the UE sleep mode is associated with a UE main radio wakeup time; and transmit a downlink control channel signal based at least in part on the UE main radio wakeup time.

In some implementations, a method of wireless communication performed by a UE includes receiving an indication of a zone pattern associated with a zone-based partitioning of an LP-WUS monitoring periodicity; receiving, during a zone associated with the zone pattern, an LP-WUS, wherein the zone is associated with a UE sleep mode, and wherein the UE sleep mode is associated with a UE main radio wakeup time; and receiving a downlink control channel signal based at least in part on the UE main radio wakeup time.

In some implementations, a method of wireless communication performed by a network node includes transmitting an indication of a zone pattern associated with a zone-based partitioning of an LP-WUS monitoring periodicity; transmitting, during a zone associated with the zone pattern, an LP-WUS, wherein the zone is associated with a UE sleep mode, and wherein the UE sleep mode is associated with a UE main radio wakeup time; and transmitting a downlink control channel signal based at least in part on the UE main radio wakeup time.

In some implementations, a non-transitory computer-readable medium storing a set of instructions for wireless communication includes one or more instructions that, when executed by one or more processors of a UE, cause the UE to: receive an indication of a zone pattern associated with a zone-based partitioning of an LP-WUS monitoring periodicity; receive, during a zone associated with the zone pattern, an LP-WUS, wherein the zone is associated with a UE sleep mode, and wherein the UE sleep mode is associated with a UE main radio wakeup time; and receive a downlink control channel signal based at least in part on the UE main radio wakeup time.

In some implementations, a non-transitory computer-readable medium storing a set of instructions for wireless communication includes one or more instructions that, when executed by one or more processors of a network node, cause the network node to: transmit an indication of a zone pattern associated with a zone-based partitioning of an LP-WUS monitoring periodicity; transmit, during a zone associated with the zone pattern, an LP-WUS, wherein the zone is associated with a UE sleep mode, and wherein the UE sleep mode is associated with a UE main radio wakeup time; and transmit a downlink control channel signal based at least in part on the UE main radio wakeup time.

In some implementations, an apparatus for wireless communication includes means for receiving an indication of a zone pattern associated with a zone-based partitioning of an LP-WUS monitoring periodicity; means for receiving, during a zone associated with the zone pattern, an LP-WUS, wherein the zone is associated with an apparatus sleep mode, and wherein the apparatus sleep mode is associated with an apparatus main radio wakeup time; and means for receiving a downlink control channel signal based at least in part on the UE main radio wakeup time.

In some implementations, an apparatus for wireless communication includes means for transmitting an indication of a zone pattern associated with a zone-based partitioning of an LP-WUS monitoring periodicity; means for transmitting, during a zone associated with the zone pattern, an LP-WUS, wherein the zone is associated with a UE sleep mode, and wherein the UE sleep mode is associated with a UE main radio wakeup time; and means for transmitting a downlink control channel signal based at least in part on the UE main radio wakeup time.

The systems, methods, and devices of this disclosure each have several innovative aspects, no single one of which is solely responsible for the desirable attributes disclosed herein.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless network.

FIG. 2 is a diagram illustrating an example disaggregated base station architecture.

FIG. 3 is a diagram illustrating an example of multiple radios in a user equipment (UE).

FIG. 4 is a diagram illustrating an example of low power wakeup signal (LP-WUS) modulation.

FIG. 5 is a diagram illustrating an example of on-off keying (OOK) symbols and orthogonal frequency division multiplexing (OFDM) sequences.

FIGS. 6-8 are diagrams illustrating examples associated with zone-based partitioning of LP-WUS monitoring periodicities.

FIG. 9 is a flowchart illustrating an example process performed, for example, by a UE.

FIG. 10 is a flowchart illustrating an example process performed, for example, by a network node.

FIGS. 11-12 are diagrams of example apparatuses for wireless communication.

### DETAILED DESCRIPTION

In a wireless network, a user equipment (UE) may support a low power wakeup signal (LP-WUS), which may serve to save UE battery power. The UE may employ a separate hardware with a simpler architecture and a lower operation power, as compared to traditional hardware, to receive the LP-WUS. The LP-WUS may serve as a heartbeat signal. The UE may include a low power wakeup receiver (LP-WUR) and a main radio. The UE may include the LP-WUR in order to support the LP-WUS. The main radio may be a legacy wireless transceiver. When the LP-WUR is enabled to monitor the LP-WUS, the main radio may be in a sleep mode for power saving. After the UE receives the LP-WUS, which may trigger a physical downlink control channel (PDCCH) monitoring for the UE, the main radio may be switched on in order to monitor a PDCCH. By allowing the main radio to be in the sleep mode when the LP-WUS is monitoring for the LP-WUS, the UE may be able to save power. The LP-WUR may have a simpler architecture and a low operation power as compared to the main radio.

The LP-WUS may be associated with an on-off keying (OOK) modulation. One bit of information may be represented by a presence or an absence of signal energy. For example, the presence of signal energy may represent a bit value of 0, and the absence of signal energy may represent a bit value of 1. When Manchester coding is able to be applied on top of OOK, a waveform associated with low voltage to high voltage may represent a bit value of 0, and a waveform associated with high voltage to low voltage may represent a bit value of 1. Multiple such waveforms may be concatenated to carry multiple bits of the LP-WUS. OOK may result in a simplest possible receiver architecture, e.g., an energy detector. Without Manchester coding, one OOK symbol may be an OOK On symbol (e.g., an On symbol of an OOK symbol) or an OOK Off symbol (e.g., an Off symbol of an OOK symbol). With Manchester coding, one OOK symbol may always contain an OOK On symbol and an OOK Off symbol.

The LP-WUS may be associated with an OOK modulation with an overlaid sequence (e.g., an overlaid OFDM sequence). The LP-WUS (e.g., information associated with the LP-WUS) may be carried by a wideband waveform that is transmitted on one or more allocated OFDM subcarriers. The wideband waveform may differ from a rectangular OOK waveform. The wideband waveform may be transmitted in a duration of an OOK On symbol for energy to be present, such that the LP-WUS may be considered to be based at least in part on the overlaid sequence. A corresponding receiver may be an OFDM receiver that detects both amplitude and phase information of the overlaid sequence. The overlaid sequence may have a higher spectral efficiency, as compared to only OOK modulation, such that more than one bit of information may be carried by the overlaid sequence within one OOK On symbol.

When the UE operates the LP-WUR, the main radio may be transitioned into the sleep mode. A deeper sleep mode may correspond to more hardware modules and/or software threads being turned off, which may result in additional power saving by the main radio. The UE may take a longer period of time (e.g., a ramp up time part of a total transition time) to wake up the main radio from the deeper sleep mode.

A sleep mode that is entered by the UE and a mechanism by which the UE switches between sleep modes may be based at least in part on a UE implementation. The UE may typically enter deeper sleep when possible. However, without an awareness of a current UE sleep mode, a network node may assume a single UE sleep mode according to a UE capability report and/or an associated wakeup delay. As assumption of the single UE sleep mode may be suboptimal for scheduling delay when the UE reports a large wakeup delay, and/or the assumption of the single UE sleep mode may be suboptimal for UE power saving if the UE reports a small wakeup delay. A lack of awareness of the current UE sleep mode by the network node may affect a scheduling delay and/or UE power saving, thereby degrading an overall system performance.

Various aspects relate generally to LP-WUSs. Some aspects more specifically relate to zone-based partitioning of LP-WUS monitoring periodicities. In some examples, a UE may receive, from a network node, an indication of a zone pattern associated with a zone-based partitioning of an LP-WUS monitoring periodicity. The zone pattern may be periodically repeated in time. A periodicity of the zone pattern may be aligned with a periodicity of UE traffic. The UE may receive, from the network node during a zone associated with the zone pattern, an LP-WUS. The zone may be associated with a UE sleep mode. The UE sleep mode may be associated with a UE main radio wakeup time. Different zones may be associated with different UE sleep modes (e.g., deep sleep mode or light sleep mode), where the different UE sleep modes may be associated with different UE main radio wakeup times. The zone may be associated with an LP-WUS configuration. The LP-WUS configuration may define at least one LP-WUS monitoring window during the zone. The LP-WUS monitoring window may contain an LP-WUS monitoring occasion. The UE may receive the LP-WUS during the LP-WUS monitoring occasion. The UE may receive, from the network node, a downlink control channel signal based at least in part on the UE main radio wakeup time. The network node may be aware of a current UE sleep mode based at least in part on the zone pattern, where the current UE sleep mode may be associated with a particular UE main radio wakeup time. The network node may transmit the downlink control channel signal after the UE is expected to wake up based at least in part on the UE main radio wakeup time.

Particular aspects of the subject matter described in this disclosure can be implemented to realize one or more of the following potential advantages. In some examples, by allowing the network node to configure a semi-static pattern of UE sleep modes, the described techniques can be used by the network node to determine the current UE sleep mode. The current UE sleep mode may correspond to the UE main radio wakeup time. The UE main radio wakeup time may define an amount of time needed for a main radio of the UE to wake up after the LP-WUS is received by a LP-WUR of the UE. When the UE is aware of the current UE sleep mode and the corresponding UE main radio wakeup time, the network node may be able to properly transmit the downlink control channel signal after the LP-WUS that indicates that the UE is to wake up the main receiver. A first downlink control channel that the UE is able to monitor may not be earlier than the UE main radio wakeup time. The network node may not transmit the downlink control channel signal an inordinate amount of time after the main radio is turned on, which may reduce a scheduling delay. The network node may also not transmit the downlink control channel signal prior to the main radio being turned on. As a result, an ability to provide the network node with a UE sleep mode awareness may improve an overall system performance.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

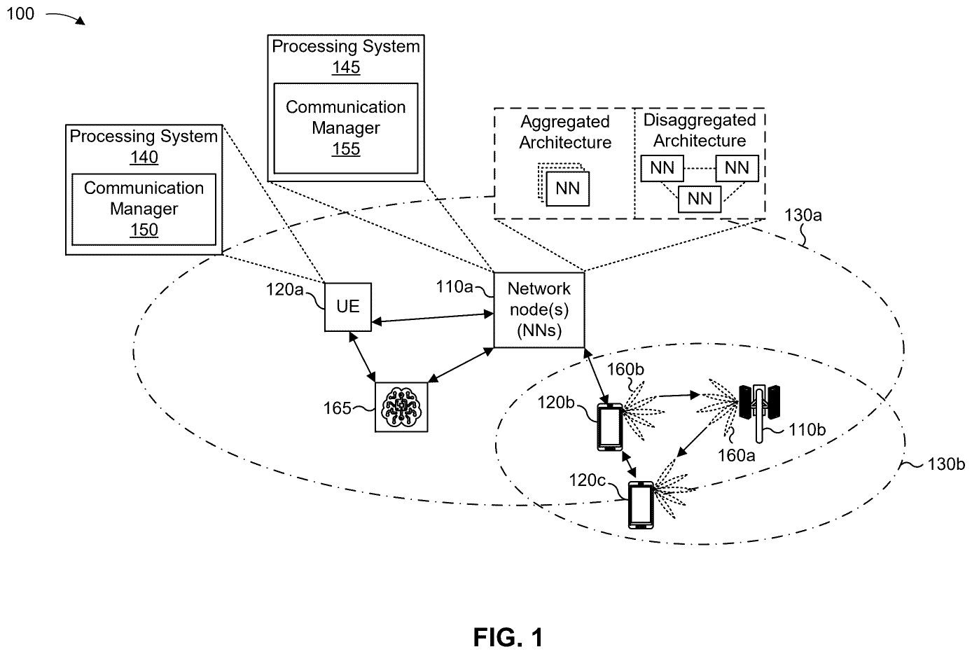

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include PDCCHs, and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In some aspects, a UE (e.g., the UE 120) may include a communication manager 150. As described in more detail elsewhere herein, the communication manager 150 may receive an indication of a zone pattern associated with a zone-based partitioning of an LP-WUS monitoring periodicity; receive, during a zone associated with the zone pattern, an LP-WUS, wherein the zone is associated with a UE sleep mode, and wherein the UE sleep mode is associated with a UE main radio wakeup time; and receive a downlink control channel signal based at least in part on the UE main radio wakeup time. Additionally, or alternatively, the communication manager 150 may perform one or more other operations described herein.

In some aspects, a network node (e.g., the network node 110) may include a communication manager 155. As described in more detail elsewhere herein, the communication manager 155 may transmit an indication of a zone pattern associated with a zone-based partitioning of an LP-WUS monitoring periodicity; transmit, during a zone associated with the zone pattern, an LP-WUS, wherein the zone is associated with a UE sleep mode, and wherein the UE sleep mode is associated with a UE main radio wakeup time; and transmit a downlink control channel signal based at least in part on the UE main radio wakeup time. Additionally, or alternatively, the communication manager 155 may perform one or more other operations described herein.

As indicated above, FIG. 1 is provided as an example. Other examples may differ from what is described with regard to FIG. 1.

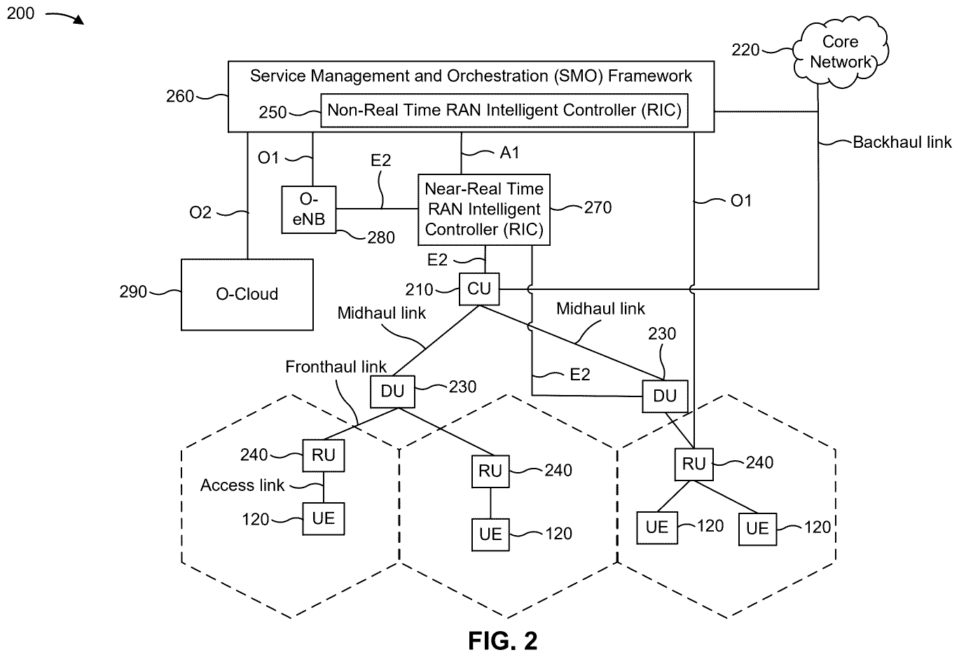

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

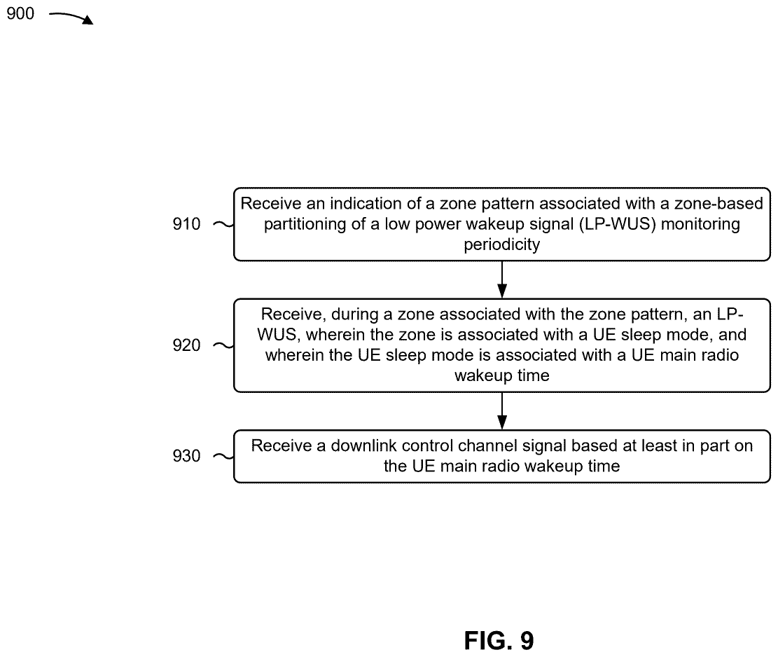

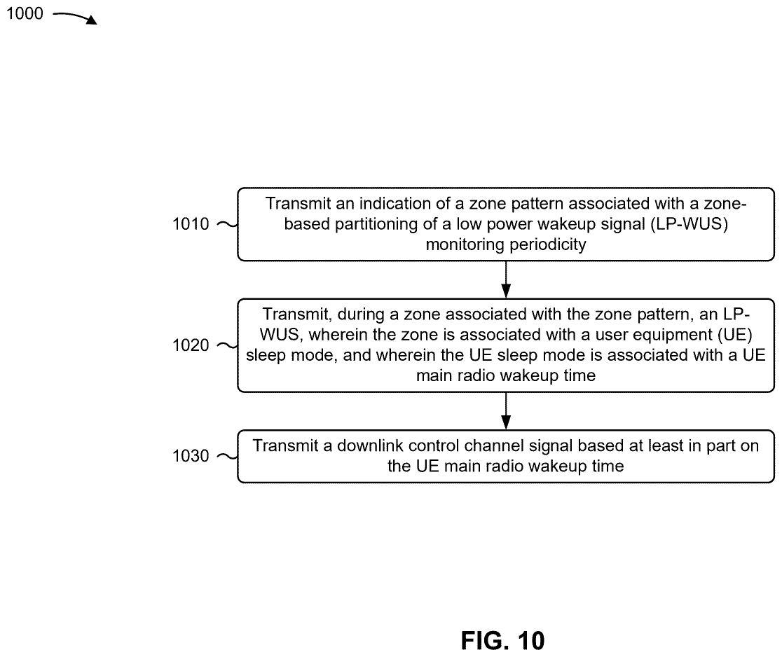

The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with zone-based partitioning of LP-WUS monitoring periodicities, as described in more detail elsewhere herein. For example, the processing system 145 of the network node 110, the processing system 140 of the UE 120, the CU 210, the DU 230, or the RU 240 may perform or direct operations of, for example, process 900 of FIG. 9, process 10 of FIG. 10, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 900 of FIG. 9, process 1000 of FIG. 10, or other processes as described herein. In some examples, executing instructions may include running the instructions, converting the instructions, compiling the instructions, or interpreting the instructions, among other examples.

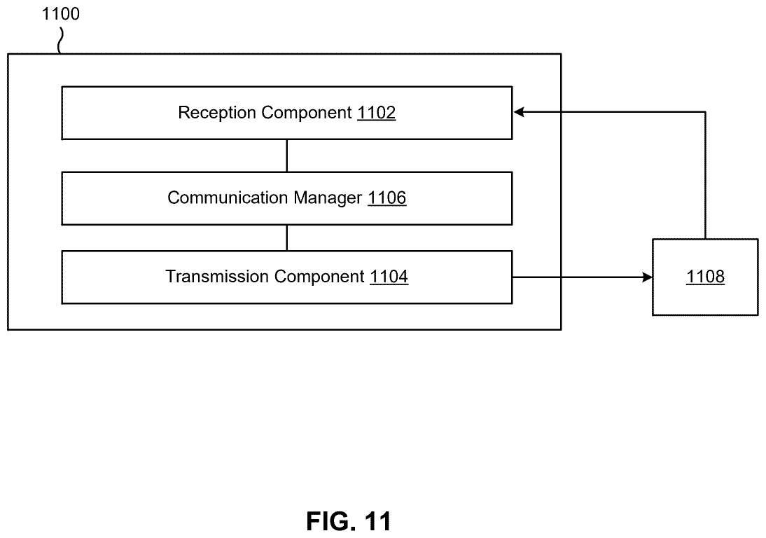

In some aspects, a UE (e.g., the UE 120) includes means for receiving an indication of a zone pattern associated with a zone-based partitioning of an LP-WUS monitoring periodicity; means for receiving, during a zone associated with the zone pattern, an LP-WUS, wherein the zone is associated with a UE sleep mode, and wherein the UE sleep mode is associated with a UE main radio wakeup time; or means for receiving a downlink control channel signal based at least in part on the UE main radio wakeup time. The means for the UE to perform operations described herein may include, for example, one or more of communication manager 150, processing system 140, a radio, one or more RF chains, one or more transceivers, one or more antennas, one or more modems, a reception component (for example, reception component 1102 depicted and described in connection with FIG. 11), or a transmission component (for example, transmission component 1104 depicted and described in connection with FIG. 11), among other examples.

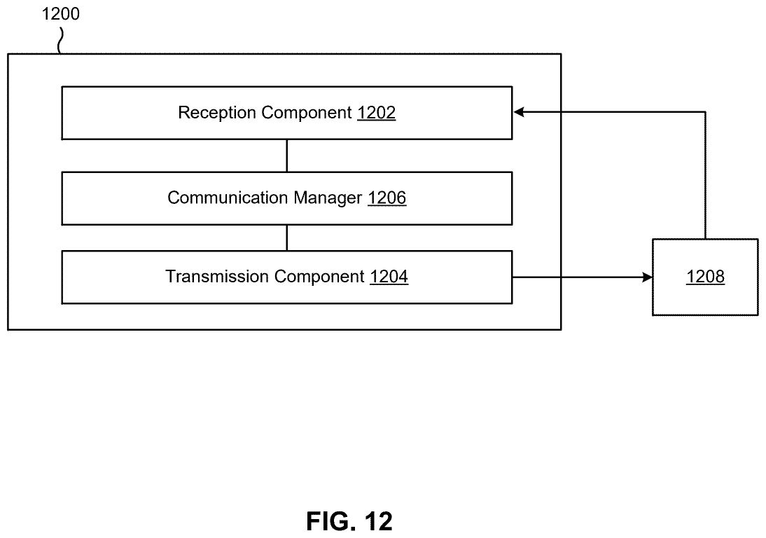

In some aspects, a network node (e.g., the network node 110) includes means for transmitting an indication of a zone pattern associated with a zone-based partitioning of an LP-WUS monitoring periodicity; means for transmitting, during a zone associated with the zone pattern, an LP-WUS, wherein the zone is associated with a UE sleep mode, and wherein the UE sleep mode is associated with a UE main radio wakeup time; or means for transmitting a downlink control channel signal based at least in part on the UE main radio wakeup time. The means for the network node to perform operations described herein may include, for example, one or more of communication manager 155, processing system 145, a radio, one or more RF chains, one or more transceivers, one or more antennas, one or more modems, a reception component (for example, reception component 1202 depicted and described in connection with FIG. 12), or a transmission component (for example, transmission component 1204 depicted and described in connection with FIG. 12), among other examples.

As indicated above, FIG. 2 is provided as an example. Other examples may differ from what is described with regard to FIG. 2.

In a wireless network, a UE may support an LP-WUS, which may serve to save UE battery power. The UE may employ a separate hardware with a simpler architecture and a lower operation power, as compared to traditional hardware, to receive the LP-WUS. The LP-WUS may serve as a heartbeat signal. For NR, the LP-WUS may trigger the UE to monitor a PDCCH signal. The LP-WUS may trigger the UE to monitor a paging PDCCH signal for RRC idle/inactive states. The LP-WUS may trigger the UE to monitor a paging early indication PDCCH signal for RRC idle/inactive states. The LP-WUS may trigger the UE to monitor a data scheduling PDCCH signal for an RRC connected state. The LP-WUS may be generated by a modulation scheme that is simpler than a modulation scheme for PDCCH, such that a detection of the LP-WUS is low power consuming.

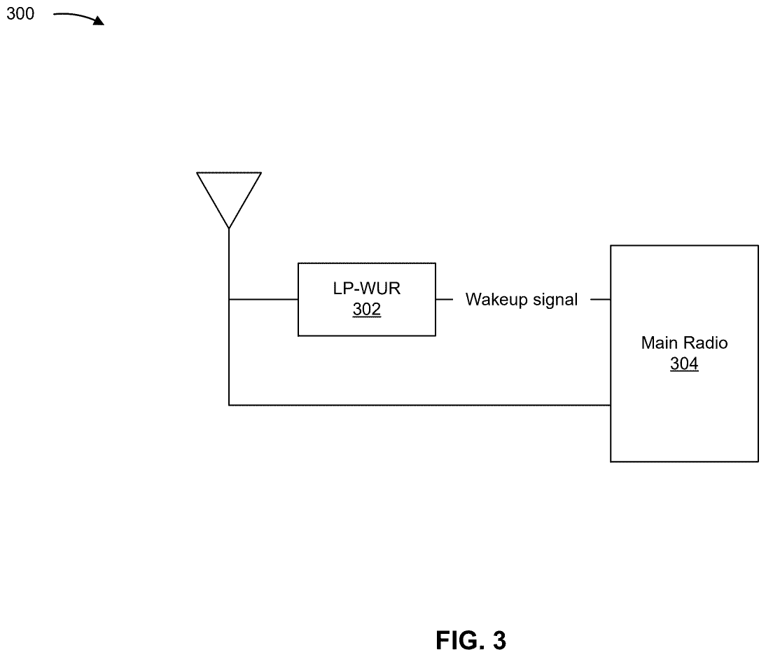

FIG. 3 is a diagram illustrating an example 300 of multiple radios in a UE.

As shown in FIG. 3, a UE may include an LP-WUR 302 and a main radio 304. The UE may include the LP-WUR 302 in order to support an LP-WUS. The main radio 304 may be a legacy wireless transceiver. When the LP-WUR 302 is enabled to monitor the LP-WUS, the main radio 304 may be in a sleep mode for power saving. After the UE receives the LP-WUS, which may trigger a PDCCH monitoring for the UE, the main radio 304 may be switched on in order to monitor a PDCCH. By allowing the main radio 304 to be in the sleep mode when the LP-WUR 302 is monitoring for the LP-WUS, the UE may be able to save power. The LP-WUR 302 may have a simpler architecture and a low operation power as compared to the main radio 304.

As indicated above, FIG. 3 is provided as an example. Other examples may differ from what is described with regard to FIG. 3.

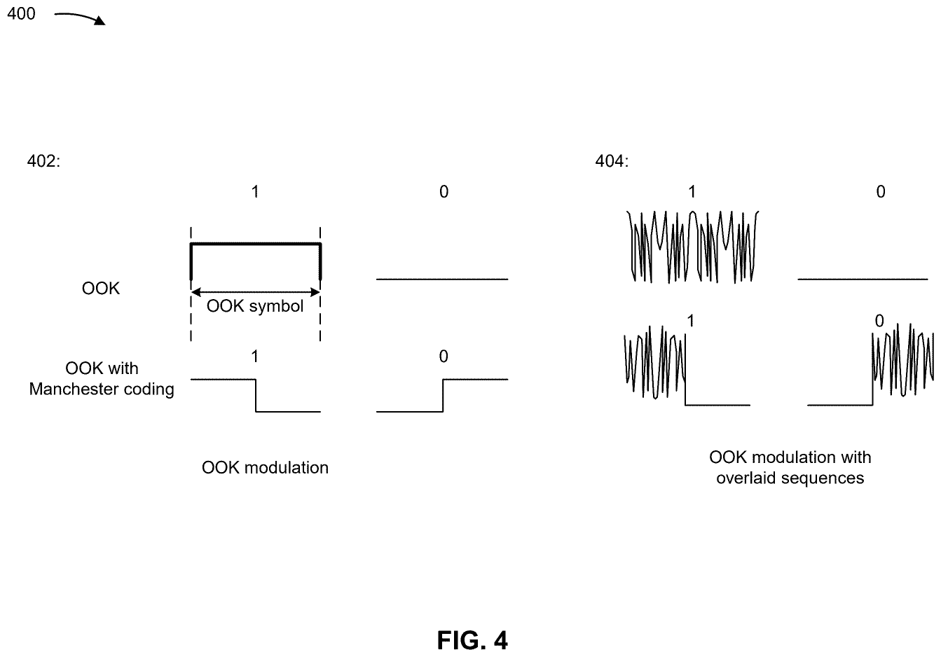

FIG. 4 is a diagram illustrating an example 400 of LP-WUS modulation.

As shown by reference number 402, an LP-WUS may be associated with an OOK modulation. One bit of information may be represented by a presence or an absence of signal energy. For example, the presence of signal energy may represent a bit value of 1, and the absence of signal energy may represent a bit value of 0. When Manchester coding is able to be applied on top of OOK, a waveform associated with low voltage to high voltage may represent a bit value of 0, and a waveform associated with high voltage to low voltage may represent a bit value of 1. Multiple such waveforms may be concatenated to carry multiple bits of the LP-WUS. OOK may result in a simplest possible receiver architecture, e.g., an energy detector. Without Manchester coding, one OOK symbol may be an OOK On symbol (e.g., an On state of an OOK symbol) or an OOK Off symbol (e.g., an Off state of an OOK symbol). With Manchester coding, one OOK symbol may always contain an OOK On symbol and an OOK Off symbol.

As shown by reference number 404, an LP-WUS may be associated with an OOK modulation with an overlaid sequence (e.g., an overlaid OFDM sequence). The LP-WUS (e.g., information associated with the LP-WUS) may be carried by a wideband waveform that is transmitted on one or more allocated OFDM subcarriers. The wideband waveform may differ from a rectangular OOK waveform. The wideband waveform may be transmitted in a duration of an OOK On symbol for energy to be present, such that the LP-WUS may be considered to be based at least in part on the overlaid sequence. A corresponding receiver may be an OFDM receiver that detects both amplitude and phase information of the overlaid sequence. The overlaid sequence may have a higher spectral efficiency, as compared to only OOK modulation, such that more than one bit of information may be carried by the overlaid sequence within one OOK On symbol.

As indicated above, FIG. 4 is provided as an example. Other examples may differ from what is described with regard to FIG. 4.

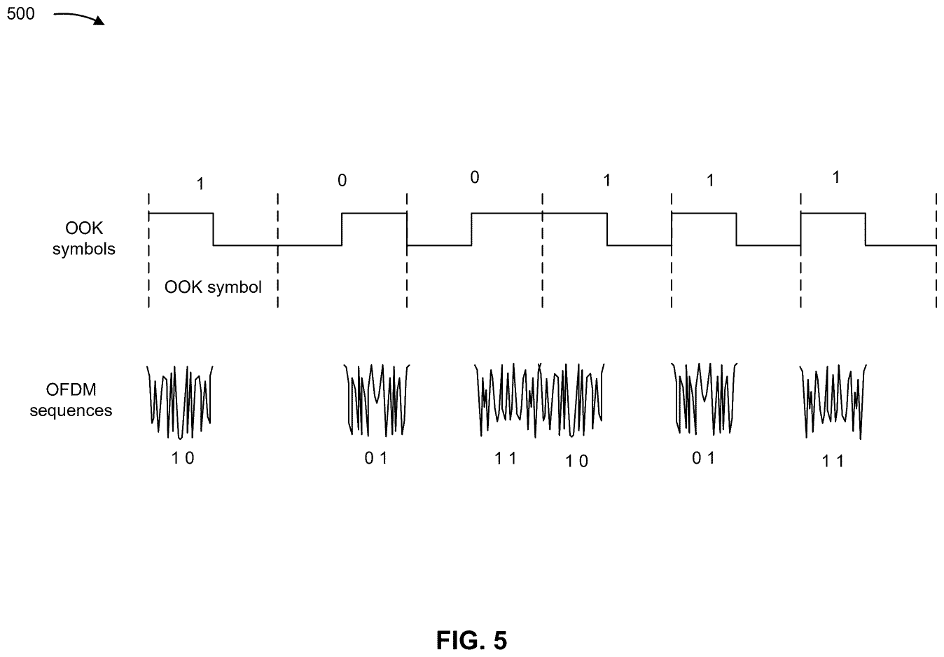

FIG. 5 is a diagram illustrating an example 500 of OOK symbols and OFDM sequences.

As shown in FIG. 5, a network node may transmit OOK symbols and OFDM sequences. An OOK symbol may be associated with a value of 0 or a value of 1, depending on a rectangular shape associated with the OOK symbol. The OFDM sequences may indicate various combinations of bit values (e.g., 10, 01, or 11). For example, a first OFDM sequence may correspond to bit values of 1 and 0, a second OFDM sequence may correspond to bit values of 0 and 1, and a third OFDM sequence may correspond to bit values of 1 and 1. A fourth OFDM sequence may correspond to bit values of 0 and 0 (not shown). When the OFDM sequences only carry part of LP-WUS information, some of the OFDM sequences may be replaced by unknown signals or signals irrelevant to an LP-WUS.

As indicated above, FIG. 5 is provided as an example. Other examples may differ from what is described with regard to FIG. 5.

In an NR system, an LP-WUS may help a UE to save battery power. The LP WUS may replace a PDCCH monitoring with an LP-WUS triggered PDCCH monitoring. LP-WUS monitoring may consume less power than PDCCH monitoring. The UE may include an LP-WUR and a main radio (e.g., a legacy wireless transceiver). When the LP-WUR is enabled to monitor the LP-WUS, the main radio may be in a sleep mode for power saving. Once the LP-WUS is received to trigger the PDCCH monitoring for the UE, the main radio may be switched on to monitor PDCCHs. The LP-WUS may be generated by OOK modulation, where a corresponding envelope detector at the UE may have a simple architecture and a lower operational power, as compared to when receiving a PDCCH signal. The LP-WUS may be modulated by overlaid OFDM sequences and detected by an OFDM receiver in a higher operational power but with better detection performance and quicker detection.

When the UE operates the LP-WUR, the main radio may be transitioned into the sleep mode. A deeper sleep mode may correspond to more hardware modules and/or software threads being turned off, which may result in additional power saving by the main radio. The UE may take a longer period of time (e.g., a ramp up time part of a total transition time) to wake up the main radio from the deeper sleep mode.

As an example, a deep sleep mode may correspond to a power consumption value of 1 unit and a total transition time of approximately 20 milliseconds (ms). A light sleep mode may correspond to a power consumption value of 20 units and a total transition time of approximately 6 ms. A micro sleep mode may correspond to a power consumption value of 45 units and a total transition time of approximately 0 ms. A smaller power consumption value may correspond to a lower amount of power consumption (more power saving), and a larger power consumption value may correspond to a higher amount of power consumption (less power saving)

A sleep mode that is entered by the UE and a mechanism by which the UE switches between sleep modes may be based at least in part on a UE implementation. The UE may typically enter deeper sleep when possible. For example, the UE may enter the deep sleep during a connected mode discontinuous reception (CDRX) inactive time when an inactive time is longer than a total transition time for deep sleep. However, without an awareness of a current UE sleep mode, a network node may assume a single UE sleep mode according to a UE capability report and/or an associated wakeup delay. As assumption of the single UE sleep mode may be suboptimal for scheduling delay when the UE reports a large wakeup delay, and/or the assumption of the single UE sleep mode may be suboptimal for UE power saving if the UE reports a small wakeup delay. A lack of awareness of the current UE sleep mode by the network node may affect a scheduling delay and/or UE power saving, thereby degrading an overall system performance.

In various aspects of techniques and apparatuses described herein, a UE may receive, from a network node, an indication of a zone pattern associated with a zone-based partitioning of an LP-WUS monitoring periodicity. The zone pattern may be periodically repeated in time. A periodicity of the zone pattern may be aligned with a periodicity of UE traffic. The UE may receive, from the network node during a zone associated with the zone pattern, an LP-WUS. The zone may be associated with a UE sleep mode. The UE sleep mode may be associated with a UE main radio wakeup time. Different zones may be associated with different UE sleep modes (e.g., ultra deep sleep mode, deep sleep mode, light sleep mode, or micro sleep mode), where the different UE sleep modes may be associated with different UE main radio wakeup times. The zone may be associated with an LP-WUS configuration. The LP-WUS configuration may define at least one LP-WUS monitoring window during the zone. The LP-WUS monitoring window may contain an LP-WUS monitoring occasion. The UE may receive the LP-WUS during the LP-WUS monitoring occasion. The UE may receive, from the network node, a downlink control channel signal, such as a PDCCH signal, based at least in part on the UE main radio wakeup time. The network node may be aware of a current UE sleep mode based at least in part on the zone pattern, where the current UE sleep mode may be associated with a particular UE main radio wakeup time. The network node may transmit the downlink control channel signal after the UE is expected to wake up based at least in part on the UE main radio wakeup time.

In some aspects, the network node may be aware of the current UE sleep mode, which may allow the network node to schedule the UE in a manner that achieves a better balance of scheduling delay and UE power saving. The network node and the UE may maintain the same knowledge of UE sleep modes for various traffics. The UE may report, to the network node, information regarding the UE's sleep modes and/or wakeup times. The network node may schedule the UE accordingly to balance power saving gain and the scheduling delay. The network node may be capable of semi-static and rule-based UE automatic sleep determination. A semi-static sleep pattern may be achieved with a zone-based partitioning of an LP-WUS monitoring periodicity. Multiple zones (e.g., four zones) may be created which repeat in time. Different zones may correspond to different sleep modes and consequently different main radio wakeup times. For example, a first zone may be for relatively deeper sleep, a second zone may be for lighter sleep, a third zone may be for other traffic, and a fourth zone may be for no LP-WUS monitoring.

In some aspects, by allowing the network node to configure a semi-static pattern of UE sleep modes, the network node may be able to determine the current UE sleep mode. The current UE sleep mode may correspond to the UE main radio wakeup time. The UE main radio wakeup time may define an amount of time needed for a main radio of the UE to wake up after the LP-WUS is received by a LP-WUR of the UE. When the UE is aware of the current UE sleep mode and the corresponding UE main radio wakeup time, the network node may be able to properly transmit the downlink control channel signal after the LP-WUS that indicates that the UE is to wake up the main radio. A first downlink control channel that the UE is able to monitor may not be earlier than the UE main radio wakeup time. The network node may not transmit the downlink control channel signal an inordinate amount of time after the main radio is turned on, which may reduce a scheduling delay. The network node may also not transmit the downlink control channel signal prior to the main radio being turned on. As a result, an ability to provide the network node with a UE sleep mode awareness may improve an overall system performance.

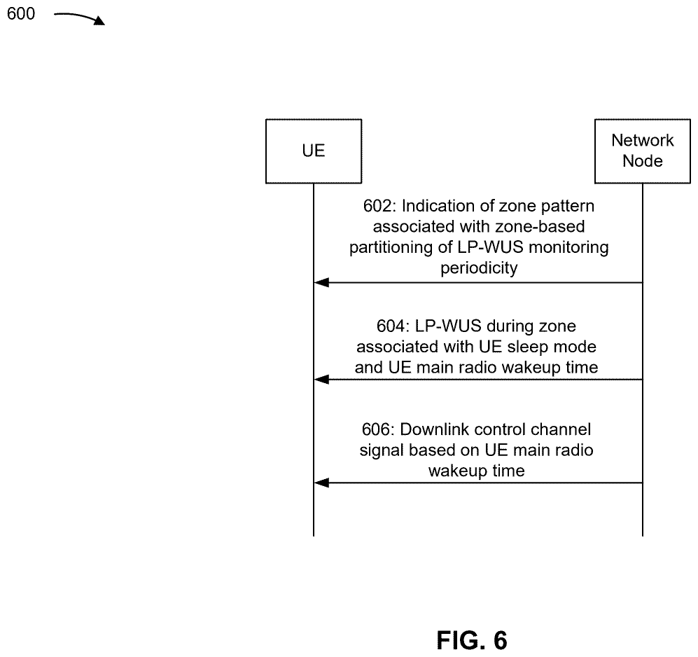

FIG. 6 is a diagram illustrating an example 600 associated with zone-based partitioning of LP-WUS monitoring periodicities. As shown in FIG. 6, example 600 includes communication between a UE (e.g., UE 120) and a network node (e.g., network node 110). In some aspects, the UE and the network node may be included in a wireless network, such as wireless network 100.

As shown by reference number 602, the UE may receive, from the network node, an indication of a zone pattern associated with a zone-based partitioning of an LP-WUS monitoring periodicity. The zone pattern may be periodically repeated in time. A periodicity of the zone pattern may be aligned with a periodicity of UE traffic. The zone pattern may include one or more zones, where different zones may be associated with different UE sleep modes (e.g., ultra deep sleep mode, deep sleep mode, light sleep mode, or micro sleep mode), and where different UE sleep modes may be associated with different UE main radio wakeup times.

As shown by reference number 604, the UE may receive, from the network node during a zone associated with the zone pattern, an LP-WUS. A duration of the zone may be based at least in part on a zone timer. The zone may be associated with a UE sleep mode. The UE sleep mode may be associated with a UE main radio wakeup time. The zone may be associated with an LP-WUS configuration. The LP-WUS configuration may define at least one LP-WUS monitoring window during the zone. The LP-WUS monitoring window may contain an LP-WUS monitoring occasion. The UE may receive the LP-WUS during the LP-WUS monitoring occasion.

As an example, the UE may enter a first UE sleep mode during a first zone of the zone pattern, where the first UE sleep mode may be associated with a first UE main radio wakeup delay. The UE may enter a second UE sleep mode during a second zone of the zone pattern, where the second UE sleep mode may be associated with a second UE main radio wakeup delay that is different than the first UE main radio wakeup delay.

In some aspects, the zone may be associated with a deep sleep mode (first sleep mode). The deep sleep mode may provide the UE with a maximum power saving as compared to other UE sleep modes for an RRC connected state. The UE main radio wakeup time may be based at least in part on the deep sleep mode. The UE main radio wakeup time may be a maximum wakeup time as compared to other UE main radio wakeup times (e.g., deeper sleep may correlate to a longer wakeup time). The zone may be associated with traffic having an uncertain arrival time. The uncertain arrival time may occur when an expected arrival time of certain traffic is not known. The tight delay budget may refer to a delay budget that satisfies a threshold value (e.g., a delay budget that is “tight” may refer to a relatively small delay budget, e.g., 10 ms), meaning that a relatively small amount of allowable delay is tolerated. The random data packet size may refer to a data packet having a variable size or having a size that does not conform to a predefined packet size.

In some aspects, the zone may be associated with a light or micro sleep mode (second sleep mode). The light or micro sleep mode may provide the UE with a minimum power saving as compared to other UE sleep modes (e.g., deep sleep mode). The UE main radio wakeup time may be based at least in part on the light or micro sleep mode. The UE main radio wakeup time may be a minimum wakeup time as compared to other UE main radio wakeup times (e.g., lighter sleep may correlate to a shorter wakeup time). The zone may be associated with delay sensitive traffic. Since the delay sensitive traffic is to be received in a shorter amount of time, the light or micro sleep mode may be employed to achieve the minimum wakeup time.

In some aspects, the UE may exit the zone and enter a next zone associated with the zone pattern. The next zone may be associated with another UE sleep mode. The UE may exit the zone and enter the next zone based at least in part on a zone timer expiry, an explicit network indication, and/or a detection of the LP-WUS that triggers the UE to monitor a downlink control channel. In some aspects, the UE may extend a duration of the zone based at least in part on a detection of the LP-WUS. A zone timer expiration time may be updated based at least in part on an extension timer value, or the UE may exit the zone based at least in part on an original zone timer and the extension timer value.

As shown by reference number 606, the UE may receive, from the network node, a downlink control channel signal, such as a PDCCH signal, based at least in part on the UE main radio wakeup time. The network node may be aware of a current UE sleep mode based at least in part on the zone pattern, where the current UE sleep mode may be associated with a particular UE main radio wakeup time. The network node may transmit the downlink control channel signal after the UE is expected to wake up based at least in part on the UE main radio wakeup time.

In some aspects, for a UE sleep mode switch, the network node may use dedicated signaling to dynamically indicate a next UE sleep mode. A dynamic indication of a UE sleep mode may be a flexible mechanism from a network scheduling perspective, but may involve difficulties in UE implementation. The network node may configure a semi-static pattern of UE sleep modes. A semi-static and rule-based UE autonomous sleep mode determination may be configured to support various traffics. The UE may autonomously determine the next UE sleep mode. In this case, the UE may autonomously determine the next UE sleep mode based at least in part on a set of rules, so that the network node may be able to keep track of UE sleep modes. In some aspects, a UE sleep mode awareness may allow the network node to determine a UE main radio wakeup delay. The UE may report, to the network node, that the UE supports multiple wakeup delay values that are associated with multiple sleep modes in its capability signaling. When the network node is aware of a current UE sleep mode, the network node may properly transmit a PDCCH signal after a LP-WUS that indicates the UE to wake up the main radio. A first PDCCH signal that the UE is able to monitor may not be earlier than the wakeup delay.

In some aspects, the zone-based partitioning of the LP-WUS monitoring periodicity may be employed, where a pattern of zones may be periodically repeated in time. The network node may configure a periodicity of a zone pattern. The periodicity may be aligned with a periodicity of critical traffic for the UE (e.g., a downlink video frame generation cycle). The zone pattern may contain one or more zones, such as a first zone, a second zone, a third zone, and a fourth zone. In this example, the zone pattern may include four zones. The network node may configure the duration for each zone. Each duration may correspond to a respective zone timer. The UE may enter different sleep modes in different zones, and different sleep modes may be associated with different UE main radio wakeup delays. Different LP-WUS configurations may be configured in different zones. Different LP-WUS monitoring window patterns may be associated with different window periodicities and different window durations. A window may contain one or more LP-WUS monitoring occasions, and an LP-WUS may be transmitted in a single LP-WUS measurement occasion. The network node may not configure the UE to monitor the LP-WUS in a final zone (e.g., a fourth zone in the zone pattern).

In some aspects, an LP-WUS configuration and a corresponding UE behavior in each zone may be defined for a typical data communication use case. In some aspects, in the first zone, the UE may stay in a relatively deeper sleep mode. The first zone may be associated with a relatively larger UE main radio wakeup delay. The UE may use the first zone in a first case or a second case. In the first case, for traffic with an uncertain arrival time (e.g., jitter), the UE may maintain a low power consumption in a deeper sleep before first data arrives. The larger UE main radio wakeup delay may achieve a similar effect to sparser UE PDCCH monitoring occasions when an LP-WUS is not configured. The UE may terminate the first zone when the UE receives the LP-WUS, which may indicate that the UE is to monitor a PDCCH. In the second case, for traffic with a tight delay budget and a random data packet size (e.g., a total size of a data cluster or a packet for the traffic), the UE may start from a relatively deeper sleep mode. When the UE is not able to fully communicate a data packet with the network node within the first zone, the UE may switch to a next zone (e.g., the second zone), which may be associated with a relatively shallower sleep mode to more quickly finish communicating remaining data before a delay deadline. The UE may terminate the first zone after a zone timer expires.

In some aspects, in the second zone, the UE may stay in the relatively shallower sleep mode. The second zone may be associated with a relatively smaller UE main radio wakeup delay. The UE may use the second zone to quickly communicate a delay sensitive data packet with the network node before the delay deadline. The UE may terminate the second zone when the zone timer expires or when the UE receives signaling from the network node. The signaling may include a PDCCH skipping indication in DCI or a MAC-CE, which may correspond to a data packet being fully transferred from the UE to the network node. In other words, the network node may only transmit the DCI or the MAC-CE after the data packet is fully transferred. The UE may extend the second zone by an extension timer. For example, the UE may exit the second zone when an original second zone timer expires or when the extension timer expires, whichever occurs later, which may correspond to the data packet not being fully transferred, such that the UE may need more scheduling opportunities in the second zone.

In some aspects, in the third zone, the UE may stay in a relatively deeper sleep mode (third sleep mode). The third zone may be associated with a relatively larger UE main radio wakeup delay. In the third zone, the network node may schedule other traffic than main traffic and with less UE power consumption. The main traffic may be traffic that determines an LP-WUS zone pattern periodicity. The other traffic may not have as tight of a delay deadline as the main traffic, but the other traffic may still need to be transferred before a next LP-WUS zone pattern period. The UE may terminate the third zone when the zone timer expires or when the UE receives signaling from the network node. The signaling may include the PDCCH skipping indication in DCI or the MAC-CE. The UE may extend the third zone by an extension timer. For example, the UE may exit the third zone when an original third zone timer expires or when the extension timer expires, whichever occurs later. The extension timer associated with the third zone may be different than the extension timer associated with the second zone.

In some aspects, in the fourth zone, the UE may not be configured to monitor the LP-WUS. The UE may not monitor a PDCCH triggered by the LP-WUS in the fourth zone. The fourth zone may be configured when there is no data to transfer or when remaining data is able to be deferred (e.g., without missing the delay deadline) to a next LP-WUS zone pattern period. The UE may determine which UE sleep mode to enter into since there is no LP-WUS triggering for PDCCH monitoring. For maximum UE power saving, the UE may stay in a deepest sleep mode that is supported by the UE, where the deepest sleep mode may have a total transition time that is smaller than or equal to a zone duration. The network node may not configure the fourth zone when a UE power consumption in the fourth zone is negligible in comparison to the UE sleep mode for a preceding zone of the zone pattern (e.g., the third zone).

In some aspects, a particular zone may be terminated. For each zone, the network node may configure a mechanism for terminating the zone, or a zone termination may be predefined in a specification. In some aspects, the UE may exit a zone (e.g., the first zone) associated with a UE sleep mode and enter a next zone (e.g., the second zone) associated with another UE sleep mode of the zone pattern. The UE may exit the zone and enter the next zone based at least in part on a first option, a second option, or a third option. In the first option, a zone timer may expire. The UE may exit the zone and enter the next zone after the zone timer expires. In the second option, the network node may explicitly indicate that the UE is to exit the zone. The UE may exit the zone and enter the next zone based at least in part on an explicit indication received from the network node. In the third option, the UE may detect the LP-WUS that triggers the UE to monitor the PDCCH. Different options may be applied for different zones.

In some aspects, the UE may autonomously extend a zone timer of a current zone to stay in the current zone for a longer period of time. The UE may extend a duration of the current zone to stay longer in the current zone when the UE detects the LP-WUS to indicate that the UE is to monitor the PDCCH. When the LP-WUS is detected at time t0, a zone timer expiration time may be updated to t0+T, where T is the extension timer value. When the LP-WUS is detected at t0 and an original zone timer expires at t1, the UE may exit the current zone at a larger time between t1 and t0+T, where T is the extension timer value.

As indicated above, FIG. 6 is provided as an example. Other examples may differ from what is described with regard to FIG. 6.

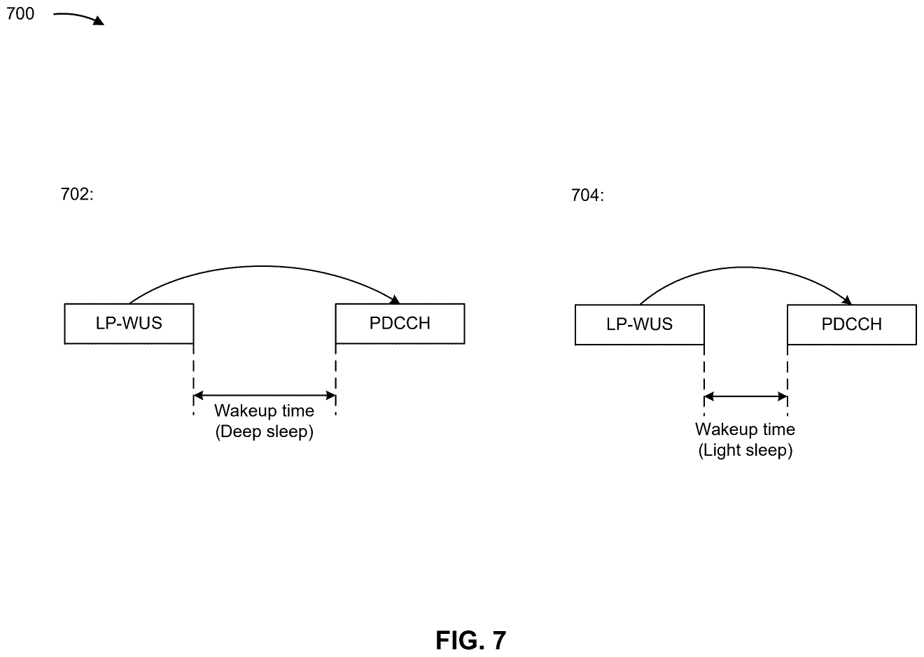

FIG. 7 is a diagram illustrating an example 700 associated with zone-based partitioning of LP-WUS monitoring periodicities.

As shown by reference number 702, a UE may receive an LP-WUS from a network node. After the UE receives the LP-WUS, the UE may wake up a main radio in accordance with a wakeup time. In other words, after the wakeup time, the main radio may be turned on and may be able to receive a PDCCH signal. A length of the wakeup time may depend on a UE sleep mode. For example, for a deep sleep mode, the wakeup time may be relatively long.

As shown by reference number 704, a UE may receive an LP-WUS from a network node. After the UE receives the LP-WUS, the UE may wake up a main radio in accordance with a wakeup time. In other words, after the wakeup time, the main radio may be turned on and may be able to receive a PDCCH signal. A length of the wakeup time may depend on a UE sleep mode. For example, for a light sleep mode, the wakeup time may be relatively short.

In some aspects, an earliest PDCCH monitoring occasion that the UE is required to monitor after the UE detects an LP-WUS may depend on a UE sleep mode. For a deep sleep mode, the earliest PDCCH monitoring occasion that the UE is required to monitor may correspond to a relatively long period after the LP-WUS is received because the UE may take a longer period of time to wake up from the deep sleep mode. For a light sleep mode, the earliest PDCCH monitoring occasion that the UE is required to monitor may correspond to a relatively short period after the LP-WUS is received because the UE may take a shorter period of time to wake up from the light sleep mode.

As indicated above, FIG. 7 is provided as an example. Other examples may differ from what is described with regard to FIG. 7.

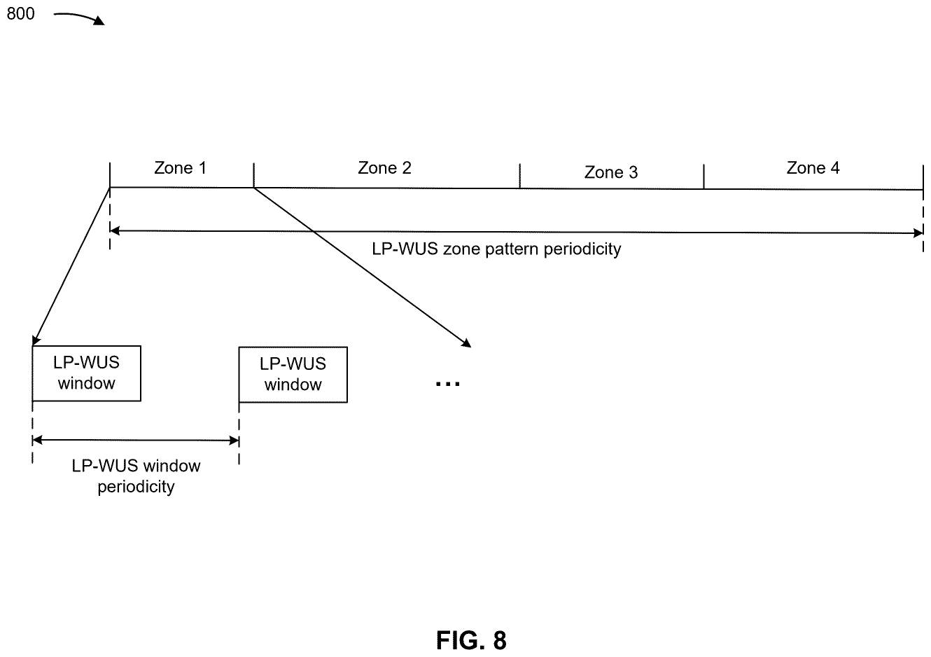

FIG. 8 is a diagram illustrating an example 800 associated with zone-based partitioning of LP-WUS monitoring periodicities.

As shown in FIG. 8, a zone pattern may include a number of zones, such as four zones. The four zones may include a first zone, a second zone, a third zone, and a fourth zone. The zone pattern may be associated with an LP-WUS zone pattern periodicity. A zone may be associated with a duration of time, where the duration of time may correspond to a zone timer. A UE may enter different sleep modes in different zones, where different sleep modes may be associated with different UE main radio wakeup delays. The zone may be associated with an LP-WUS configuration. For example, the first zone may be associated with multiple LP-WUS monitoring windows. An LP-WUS monitoring window may be associated with an LP-WUS window periodicity. The LP-WUS monitoring window may contain one or more LP-WUS monitoring occasions, where an LP-WUS may be transmitted in a single LP-WUS monitoring occasion.

As indicated above, FIG. 8 is provided as an example. Other examples may differ from what is described with regard to FIG. 8.

FIG. 9 is a diagram illustrating an example process 900 performed, for example, at a UE or an apparatus of a UE. Example process 900 is an example where the apparatus or the UE (e.g., UE 120) performs operations associated with zone-based partitioning of LP-WUS monitoring periodicities.

As shown in FIG. 9, in some aspects, process 900 may include receiving an indication of a zone pattern associated with a zone-based partitioning of an LP-WUS monitoring periodicity (block 910). For example, the UE (e.g., using reception component 1102 or communication manager 1106, depicted in FIG. 11) may receive an indication of a zone pattern associated with a zone-based partitioning of an LP-WUS monitoring periodicity, as described above.

As further shown in FIG. 9, in some aspects, process 900 may include receiving, during a zone associated with the zone pattern, an LP-WUS, wherein the zone is associated with a UE sleep mode, and wherein the UE sleep mode is associated with a UE main radio wakeup time (block 920). For example, the UE (e.g., using reception component 1102 or communication manager 1106, depicted in FIG. 11) may receive, during a zone associated with the zone pattern, an LP-WUS, wherein the zone is associated with a UE sleep mode, and wherein the UE sleep mode is associated with a UE main radio wakeup time, as described above.

As further shown in FIG. 9, in some aspects, process 900 may include receiving a downlink control channel signal based at least in part on the UE main radio wakeup time (block 930). For example, the UE (e.g., using reception component 1102 or communication manager 1106, depicted in FIG. 11) may receive a downlink control channel signal based at least in part on the UE main radio wakeup time, as described above.

Process 900 may include additional aspects, such as any single aspect or any combination of aspects described below or in connection with one or more other processes described elsewhere herein.

In a first aspect, the zone pattern is periodically repeated in time, and a periodicity of the zone pattern is aligned with a periodicity of UE traffic.

In a second aspect, alone or in combination with the first aspect, a duration of the zone is based at least in part on a zone timer.

In a third aspect, alone or in combination with one or more of the first and second aspects, process 900 includes entering a first UE sleep mode during a first zone of the zone pattern, wherein the first UE sleep mode is associated with a first UE main radio wakeup delay; and entering a second UE sleep mode during a second zone of the zone pattern, wherein the second UE sleep mode is associated with a second UE main radio wakeup delay that is different than the first UE main radio wakeup delay.

In a fourth aspect, alone or in combination with one or more of the first through third aspects, the zone is associated with an LP-WUS configuration, wherein the LP-WUS configuration defines at least one LP-WUS monitoring window during the zone, wherein the LP-WUS monitoring window contains an LP-WUS monitoring occasion, and the LP-WUS is received during the LP-WUS monitoring occasion.

In a fifth aspect, alone or in combination with one or more of the first through fourth aspects, a final zone associated with the zone pattern is not configured for an LP-WUS monitoring.

In a sixth aspect, alone or in combination with one or more of the first through fifth aspects, the zone is associated with a first sleep mode, wherein the UE main radio wakeup time is based at least in part on the first sleep mode, and the zone is associated with traffic having an uncertain arrival time, a tight delay budget, or a random data packet size.

In a seventh aspect, alone or in combination with one or more of the first through sixth aspects, the zone is associated with a second sleep mode, wherein the UE main radio wakeup time is based at least in part on the second sleep mode, and the zone is associated with delay sensitive traffic.

In an eighth aspect, alone or in combination with one or more of the first through seventh aspects, the zone is associated with a third sleep mode, wherein the UE main radio wakeup time is based at least in part on the third sleep mode, wherein the zone is associated with other traffic that is different than main traffic used to determine an LP-WUS zone pattern periodicity, and the other traffic is to be transferred prior to a next zone pattern.

In a ninth aspect, alone or in combination with one or more of the first through eighth aspects, process 900 includes exiting the zone and entering a next zone associated with the zone pattern, wherein the next zone is associated with another UE sleep mode, wherein the exiting of the zone and the entering the next zone is based at least in part on a zone timer expiry, an explicit network indication, or a detection of the LP-WUS that triggers the UE to monitor a downlink control channel.

In a tenth aspect, alone or in combination with one or more of the first through ninth aspects, process 900 includes extending a duration of the zone based at least in part on a detection of the LP-WUS, wherein a zone timer expiration time is updated based at least in part on an extension timer value, or the UE exits the zone based at least in part on an original zone timer and the extension timer value.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a network node or an apparatus of a network node. Example process 1000 is an example where the apparatus or the network node (e.g., network node 110) performs operations associated with zone-based partitioning of LP-WUS monitoring periodicities.

As shown in FIG. 10, in some aspects, process 1000 may include transmitting an indication of a zone pattern associated with a zone-based partitioning of an LP-WUS monitoring periodicity (block 1010). For example, the network node (e.g., using transmission component 1204 or communication manager 1206, depicted in FIG. 12) may transmit an indication of a zone pattern associated with a zone-based partitioning of an LP-WUS monitoring periodicity, as described above.

As further shown in FIG. 10, in some aspects, process 1000 may include transmitting, during a zone associated with the zone pattern, an LP-WUS, wherein the zone is associated with a UE sleep mode, and wherein the UE sleep mode is associated with a UE main radio wakeup time (block 1020). For example, the network node (e.g., using transmission component 1204 or communication manager 1206, depicted in FIG. 12) may transmit, during a zone associated with the zone pattern, an LP-WUS, wherein the zone is associated with a UE sleep mode, and wherein the UE sleep mode is associated with a UE main radio wakeup time, as described above.

As further shown in FIG. 10, in some aspects, process 1000 may include transmitting a downlink control channel signal based at least in part on the UE main radio wakeup time (block 1030). For example, the network node (e.g., using transmission component 1204 or communication manager 1206, depicted in FIG. 12) may transmit a downlink control channel signal based at least in part on the UE main radio wakeup time, as described above.

Process 1000 may include additional aspects, such as any single aspect or any combination of aspects described below or in connection with one or more other processes described elsewhere herein.

In a first aspect, the zone pattern is periodically repeated in time, and a periodicity of the zone pattern is aligned with a periodicity of UE traffic.

In a second aspect, alone or in combination with the first aspect, a duration of the zone is based at least in part on a zone timer.

In a third aspect, alone or in combination with one or more of the first and second aspects, the zone is associated with an LP-WUS configuration, wherein the LP-WUS configuration defines at least one LP-WUS monitoring window during the zone, wherein the LP-WUS monitoring window contains an LP-WUS monitoring occasion, and the LP-WUS is received during the LP-WUS monitoring occasion.

In a fourth aspect, alone or in combination with one or more of the first through third aspects, a final zone associated with the zone pattern is not configured for an LP-WUS monitoring.

In a fifth aspect, alone or in combination with one or more of the first through fourth aspects, the zone is associated with a first sleep mode, wherein the UE main radio wakeup time is based at least in part on the first sleep mode, and the zone is associated with traffic having an uncertain arrival time, a tight delay budget, or a random data packet size.

In a sixth aspect, alone or in combination with one or more of the first through fifth aspects, the zone is associated with a second sleep mode, wherein the UE main radio wakeup time is based at least in part on the second sleep mode, and the zone is associated with delay sensitive traffic.

In a seventh aspect, alone or in combination with one or more of the first through sixth aspects, the zone is associated with a third sleep mode, wherein the UE main radio wakeup time is based at least in part on the third sleep mode, wherein the zone is associated with other traffic that is different than main traffic used to determine an LP-WUS zone pattern periodicity, and the other traffic is to be transferred prior to a next zone pattern.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication. The apparatus 1100 may be a UE, or a UE may include the apparatus 1100. In some aspects, the apparatus 1100 includes a reception component 1102, a transmission component 1104, or a communication manager 1106, which may be in communication with one another (for example, via one or more buses or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104. The communication manager 1106 may be included in, or implemented via, a processing system (for example, the processing system 140 described in connection with FIG. 1) of the UE.

In some aspects, the apparatus 1100 may be configured to perform one or more operations described herein in connection with FIGS. 6-8. Additionally, or alternatively, the apparatus 1100 may be configured to perform one or more processes described herein, such as process 900 of FIG. 9. In some aspects, the apparatus 1100 or one or more components shown in FIG. 11 may include one or more components of the UE described in connection with FIG. 1. Additionally, or alternatively, one or more components shown in FIG. 11 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications, and may provide the processed signals to the one or more other components of the apparatus 1100. In some aspects, the reception component 1102 may include one or more components of the UE described above in connection with FIG. 1, such as a radio, one or more RF chains, one or more transceivers, or one or more modems, each of which may in turn be coupled with one or more antennas of the UE.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications, and may transmit the processed signals to the apparatus 1108. In some aspects, the transmission component 1104 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1104 may be co-located with the reception component 1102.

The communication manager 1106 may support operations of the reception component 1102 or the transmission component 1104. For example, the communication manager 1106 may receive information associated with configuring reception of communications by the reception component 1102 or transmission of communications by the transmission component 1104. Additionally, or alternatively, the communication manager 1106 may generate or provide control information to the reception component 1102 or the transmission component 1104 to control reception or transmission of communications.

The reception component 1102 may receive an indication of a zone pattern associated with a zone-based partitioning of an LP-WUS monitoring periodicity. The reception component 1102 may receive, during a zone associated with the zone pattern, an LP-WUS, wherein the zone is associated with a UE sleep mode, and wherein the UE sleep mode is associated with a UE main radio wakeup time. The reception component 1102 may receive a downlink control channel signal based at least in part on the UE main radio wakeup time.

The communication manager 1106 may enter a first UE sleep mode during a first zone of the zone pattern, wherein the first UE sleep mode is associated with a first UE main radio wakeup delay. The communication manager 1106 may enter a second UE sleep mode during a second zone of the zone pattern, wherein the second UE sleep mode is associated with a second UE main radio wakeup delay that is different than the first UE main radio wakeup delay. The communication manager 1106 may exit the zone and entering a next zone associated with the zone pattern, wherein the next zone is associated with another UE sleep mode, wherein the exiting of the zone and the entering the next zone is based at least in part on: a zone timer expiry, an explicit network indication, or a detection of the LP-WUS that triggers the UE to monitor a downlink control channel. The communication manager 1106 may extend a duration of the zone based at least in part on a detection of the LP-WUS, wherein a zone timer expiration time is updated based at least in part on an extension timer value, or wherein the UE exits the zone based at least in part on an original zone timer and the extension timer value.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication. The apparatus 1200 may be a network node, or a network node may include the apparatus 1200. In some aspects, the apparatus 1200 includes a reception component 1202, a transmission component 1204, or a communication manager 1206, which may be in communication with one another (for example, via one or more buses or one or more other components). In some aspects, the communication manager 1206 is the communication manager 155 described in connection with FIG. 1. As shown, the apparatus 1200 may communicate with another apparatus 1208, such as a UE or a network node (such as a CU, a DU, an RU, or a base station), using the reception component 1202 and the transmission component 1204. The communication manager 1206 may be included in, or implemented via, a processing system (for example, the processing system 145 described in connection with FIG. 1) of the network node.

In some aspects, the apparatus 1200 may be configured to perform one or more operations described herein in connection with FIGS. 6-8. Additionally, or alternatively, the apparatus 1200 may be configured to perform one or more processes described herein, such as process 1000 of FIG. 10. In some aspects, the apparatus 1200 or one or more components shown in FIG. 12 may include one or more components of the network node described in connection with FIG. 1. Additionally, or alternatively, one or more components shown in FIG. 12 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications, and may provide the processed signals to the one or more other components of the apparatus 1200. In some aspects, the reception component 1202 may include one or more components of the network node described above in connection with FIG. 1, such as a radio, one or more RF chains, one or more transceivers, or one or more modems, each of which may in turn be coupled with one or more antennas of the network node. In some aspects, the reception component 1202 or the transmission component 1204 may include or may be included in a network interface. The network interface may be configured to obtain or output signals for the apparatus 1200 via one or more communications links, such as a backhaul link, a midhaul link, or a fronthaul link.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications, and may transmit the processed signals to the apparatus 1208. In some aspects, the transmission component 1204 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1204 may be co-located with the reception component 1202.

The communication manager 1206 may support operations of the reception component 1202 or the transmission component 1204. For example, the communication manager 1206 may receive information associated with configuring reception of communications by the reception component 1202 or transmission of communications by the transmission component 1204. Additionally, or alternatively, the communication manager 1206 may generate or provide control information to the reception component 1202 or the transmission component 1204 to control reception or transmission of communications.

The transmission component 1204 may transmit an indication of a zone pattern associated with a zone-based partitioning of an LP-WUS monitoring periodicity. The transmission component 1204 may transmit, during a zone associated with the zone pattern, an LP-WUS, wherein the zone is associated with a UE sleep mode, and wherein the UE sleep mode is associated with a UE main radio wakeup time. The transmission component 1204 may transmit a downlink control channel signal based at least in part on the UE main radio wakeup time.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:
Aspect 1: A method of wireless communication performed by a user equipment (UE), comprising: receiving an indication of a zone pattern associated with a zone-based partitioning of a low power wakeup signal (LP-WUS) monitoring periodicity; receiving, during a zone associated with the zone pattern, an LP-WUS, wherein the zone is associated with a UE sleep mode, and wherein the UE sleep mode is associated with a UE main radio wakeup time; and receiving a downlink control channel signal based at least in part on the UE main radio wakeup time.
Aspect 2: The method of Aspect 1, wherein the zone pattern is periodically repeated in time, and wherein a periodicity of the zone pattern is aligned with a periodicity of UE traffic.
Aspect 3: The method of any of Aspects 1-2, wherein a duration of the zone is based at least in part on a zone timer.
Aspect 4: The method of any of Aspects 1-3, further comprising: entering a first UE sleep mode during a first zone of the zone pattern, wherein the first UE sleep mode is associated with a first UE main radio wakeup delay; and entering a second UE sleep mode during a second zone of the zone pattern, wherein the second UE sleep mode is associated with a second UE main radio wakeup delay that is different than the first UE main radio wakeup delay.
Aspect 5: The method of any of Aspects 1-4, wherein the zone is associated with an LP-WUS configuration, wherein the LP-WUS configuration defines at least one LP-WUS monitoring window during the zone, wherein the LP-WUS monitoring window contains an LP-WUS monitoring occasion, and wherein the LP-WUS is received during the LP-WUS monitoring occasion.
Aspect 6: The method of any of Aspects 1-5, wherein a final zone associated with the zone pattern is not configured for an LP-WUS monitoring.
Aspect 7: The method of any of Aspects 1-6, wherein the zone is associated with a first sleep mode, wherein the UE main radio wakeup time is based at least in part on the first sleep mode, and wherein the zone is associated with traffic having an uncertain arrival time, a tight delay budget, or a random data packet size.
Aspect 8: The method of any of Aspects 1-7, wherein the zone is associated with a second sleep mode, wherein the UE main radio wakeup time is based at least in part on the second sleep mode, and wherein the zone is associated with delay sensitive traffic.
Aspect 9: The method of any of Aspects 1-8, wherein the zone is associated with a third sleep mode, wherein the UE main radio wakeup time is based at least in part on the third sleep mode, wherein the zone is associated with other traffic that is different than main traffic used to determine an LP-WUS zone pattern periodicity, and wherein the other traffic is to be transferred prior to a next zone pattern.
Aspect 10: The method of any of Aspects 1-9, further comprising: exiting the zone and entering a next zone associated with the zone pattern, wherein the next zone is associated with another UE sleep mode, wherein the exiting of the zone and the entering the next zone is based at least in part on: a zone timer expiry, an explicit network indication, or a detection of the LP-WUS that triggers the UE to monitor a downlink control channel.
Aspect 11: The method of any of Aspects 1-10, further comprising: extending a duration of the zone based at least in part on a detection of the LP-WUS, wherein a zone timer expiration time is updated based at least in part on an extension timer value, or wherein the UE exits the zone based at least in part on an original zone timer and the extension timer value.
Aspect 12: A method of wireless communication performed by a network node, comprising: transmitting an indication of a zone pattern associated with a zone-based partitioning of a low power wakeup signal (LP-WUS) monitoring periodicity; transmitting, during a zone associated with the zone pattern, an LP-WUS, wherein the zone is associated with a user equipment (UE) sleep mode, and wherein the UE sleep mode is associated with a UE main radio wakeup time; and transmitting a downlink control channel signal based at least in part on the UE main radio wakeup time.
Aspect 13: The method of Aspect 12, wherein the zone pattern is periodically repeated in time, and wherein a periodicity of the zone pattern is aligned with a periodicity of UE traffic.
Aspect 14: The method of any of Aspects 12-13, wherein a duration of the zone is based at least in part on a zone timer.
Aspect 15: The method of any of Aspects 12-14, wherein the zone is associated with an LP-WUS configuration, wherein the LP-WUS configuration defines at least one LP-WUS monitoring window during the zone, wherein the LP-WUS monitoring window contains an LP-WUS monitoring occasion, and wherein the LP-WUS is received during the LP-WUS monitoring occasion.
Aspect 16: The method of any of Aspects 12-15, wherein a final zone associated with the zone pattern is not configured for an LP-WUS monitoring.
Aspect 17: The method of any of Aspects 12-16, wherein the zone is associated with a first sleep mode, wherein the UE main radio wakeup time is based at least in part on the first sleep mode, and wherein the zone is associated with traffic having an uncertain arrival time, a tight delay budget, or a random data packet size.
Aspect 18: The method of any of Aspects 12-17, wherein the zone is associated with a second sleep mode, wherein the UE main radio wakeup time is based at least in part on the second sleep mode, and wherein the zone is associated with delay sensitive traffic.
Aspect 19: The method of any of Aspects 12-18, wherein the zone is associated with a third sleep mode, wherein the UE main radio wakeup time is based at least in part on the third sleep mode, wherein the zone is associated with other traffic that is different than main traffic used to determine an LP-WUS zone pattern periodicity, and wherein the other traffic is to be transferred prior to a next zone pattern.
Aspect 20: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-19.
Aspect 21: An apparatus for wireless communication at a device, the apparatus comprising one or more memories and one or more processors coupled to the one or more memories, the one or more processors configured to cause the device to perform the method of one or more of Aspects 1-19.
Aspect 22: An apparatus for wireless communication, the apparatus comprising at least one means for performing the method of one or more of Aspects 1-19.
Aspect 23: A non-transitory computer-readable medium storing code for wireless communication, the code comprising instructions executable by one or more processors to perform the method of one or more of Aspects 1-19.
Aspect 24: A non-transitory computer-readable medium storing a set of instructions for wireless communication, the set of instructions comprising one or more instructions that, when executed by one or more processors of a device, cause the device to perform the method of one or more of Aspects 1-19.
Aspect 25: A device for wireless communication, the device comprising a processing system that includes one or more processors and one or more memories coupled with the one or more processors, the processing system configured to cause the device to perform the method of one or more of Aspects 1-19.
Aspect 26: An apparatus for wireless communication at a device, the apparatus comprising one or more memories and one or more processors coupled to the one or more memories, the one or more processors individually or collectively configured to cause the device to perform the method of one or more of Aspects 1-19.
Aspect 27: A device comprising a processing system that includes one or more processors and one or more code-storing memories coupled with the one or more processors, the processing system configured to cause the device to perform the method of one or more of Aspects 1-19.
Aspect 28: A device comprising a processing system that includes processor circuitry and code-storing memory circuitry, the processing system configured to cause the device to perform the method of one or more of Aspects 1-19.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors, coupled to the one or more memories, configured to cause the UE to:
receive an indication of a zone pattern associated with a zone-based partitioning of a low power wakeup signal (LP-WUS) monitoring periodicity;
receive, during a zone associated with the zone pattern, an LP-WUS, wherein the zone is associated with a UE sleep mode, and wherein the UE sleep mode is associated with a UE main radio wakeup time; and
receive a downlink control channel signal based at least in part on the UE main radio wakeup time.

2. The apparatus of claim 1, wherein the zone pattern is periodically repeated in time, and wherein a periodicity of the zone pattern is aligned with a periodicity of UE traffic.

3. The apparatus of claim 1, wherein a duration of the zone is based at least in part on a zone timer.

4. The apparatus of claim 1, wherein the one or more processors are further configured to cause the UE to:
enter a first UE sleep mode during a first zone of the zone pattern, wherein the first UE sleep mode is associated with a first UE main radio wakeup delay; and
enter a second UE sleep mode during a second zone of the zone pattern, wherein the second UE sleep mode is associated with a second UE main radio wakeup delay that is different than the first UE main radio wakeup delay.

5. The apparatus of claim 1, wherein the zone is associated with an LP-WUS configuration, wherein the LP-WUS configuration defines at least one LP-WUS monitoring window during the zone, wherein the LP-WUS monitoring window contains an LP-WUS monitoring occasion, and wherein the LP-WUS is received during the LP-WUS monitoring occasion.

6. The apparatus of claim 1, wherein a final zone associated with the zone pattern is not configured for an LP-WUS monitoring.

7. The apparatus of claim 1, wherein the zone is associated with a first sleep mode, wherein the UE main radio wakeup time is based at least in part on the first sleep mode, and wherein the zone is associated with traffic having an uncertain arrival time, a tight delay budget, or a random data packet size.

8. The apparatus of claim 1, wherein the zone is associated with a second sleep mode, wherein the UE main radio wakeup time is based at least in part on the second sleep mode, and wherein the zone is associated with delay sensitive traffic.

9. The apparatus of claim 1, wherein the zone is associated with a third sleep mode, wherein the UE main radio wakeup time is based at least in part on the third sleep mode, wherein the zone is associated with other traffic that is different than main traffic used to determine an LP-WUS zone pattern periodicity, and wherein the other traffic is to be transferred prior to a next zone pattern.

10. The apparatus of claim 1, wherein the one or more processors are further configured to cause the UE to:
exit the zone and enter a next zone associated with the zone pattern, wherein the next zone is associated with another UE sleep mode, wherein the exiting of the zone and the entering the next zone is based at least in part on: a zone timer expiry, an explicit network indication, or a detection of the LP-WUS that triggers the UE to monitor a downlink control channel.

11. The apparatus of claim 1, wherein the one or more processors are further configured to cause the UE to:
extend a duration of the zone based at least in part on a detection of the LP-WUS, wherein a zone timer expiration time is updated based at least in part on an extension timer value, or wherein the UE exits the zone based at least in part on an original zone timer and the extension timer value.

12. An apparatus for wireless communication at a network node, comprising:
one or more memories; and
one or more processors, coupled to the one or more memories, configured to cause the network node to:
transmit an indication of a zone pattern associated with a zone-based partitioning of a low power wakeup signal (LP-WUS) monitoring periodicity;
transmit, during a zone associated with the zone pattern, an LP-WUS, wherein the zone is associated with a user equipment (UE) sleep mode, and wherein the UE sleep mode is associated with a UE main radio wakeup time; and
transmit a downlink control channel signal based at least in part on the UE main radio wakeup time.

13. The apparatus of claim 12, wherein the zone pattern is periodically repeated in time, and wherein a periodicity of the zone pattern is aligned with a periodicity of UE traffic.

14. The apparatus of claim 12, wherein a duration of the zone is based at least in part on a zone timer.

15. The apparatus of claim 12, wherein the zone is associated with an LP-WUS configuration, wherein the LP-WUS configuration defines at least one LP-WUS monitoring window during the zone, wherein the LP-WUS monitoring window contains an LP-WUS monitoring occasion, and wherein the LP-WUS is received during the LP-WUS monitoring occasion.

16. The apparatus of claim 12, wherein a final zone associated with the zone pattern is not configured for an LP-WUS monitoring.

17. The apparatus of claim 12, wherein the zone is associated with a first sleep mode, wherein the UE main radio wakeup time is based at least in part on the first sleep mode, and wherein the zone is associated with traffic having an uncertain arrival time, a tight delay budget, or a random data packet size.

18. The apparatus of claim 12, wherein the zone is associated with a second sleep mode, wherein the UE main radio wakeup time is based at least in part on the second sleep mode, and wherein the zone is associated with delay sensitive traffic.

19. The apparatus of claim 12, wherein the zone is associated with a third sleep mode, wherein the UE main radio wakeup time is based at least in part on the third sleep mode, wherein the zone is associated with other traffic that is different than main traffic used to determine an LP-WUS zone pattern periodicity, and wherein the other traffic is to be transferred prior to a next zone pattern.

20. A method of wireless communication performed by a user equipment (UE), comprising:
receiving an indication of a zone pattern associated with a zone-based partitioning of a low power wakeup signal (LP-WUS) monitoring periodicity;
receiving, during a zone associated with the zone pattern, an LP-WUS, wherein the zone is associated with a UE sleep mode, and wherein the UE sleep mode is associated with a UE main radio wakeup time; and
receiving a downlink control channel signal based at least in part on the UE main radio wakeup time.
